(19) United States
(12) Patent Application Publication
(10) Pub. No.: US 2006/0158455 A1
(43) Pub. Date: Jul. 20, 2006

(54) Real clear 3D multi-user communicator

(76) Inventor: Kazutora Yoshino, Eden Prairie, MN (US)

Correspondence Address: KAZUTORA YOSHINO, 7227 Divinity Ln., Eden Prairie, MN, 55346, US

(21) Appl. No.: 11/036,787

(22) Filed: Jan. 18, 2005

(51) Int. Cl. G09G 5/00

(52) U.S. Cl. 345/589; 345/4

(57) ABSTRACT

Color 3D image display devices that show realistic 3D images using right images for right eye and left images for left eyes. Multi-users can view the 3D images from different angles. The size of data is small enough to be practical. Location changeable slots means such as liquid crystal slots are used to have realistic 3D images.

This invention relates to the image display devices such as 3DTV, hologram, stereo display device, volumetric display device that are used for displaying the 3 dimensional object or images.

### BACKGROUND—DESCRIPTION OF PRIOR ART

In the conventional way, it was difficult to display the 3 dimensional object or images in real time (run time) by viewed by the multiple users without special glasses in the space only by light. So devices such as TV are showing the converted 2 dimensional images from the 3 dimensional objects.

There are some 3 dimensional displays available.

The virtual headsets are showing the two different images to each eye of users by screens to create the 3 dimensional images. The shutter glasses can also show 3D images having fast changing alternating left and right images. But many people feel uncomfortable wearing such devices and some gets cyber sick easily.

The holograms are showing 3 dimensional images, but these images are difficult to be changed in real time (run time).

The conventional method to project the 2 dimensional image to rotating plate, spiral screen, reciprocating screen to create 3 dimensional image shows only the surface shape of images and they don't show realistic 3 dimensional image. (Actuality, Felix, Act Research) The conventional method to project the 2 dimensional images to plurality of semi-transparent plates to create 3 dimensional images are very expensive because multiple DMD, GLV costs a lot. U.S. Pat. No. 5,394,202 (Deering, 1995) and U.S. Pat. No. 5,907,312, (Sato, et al., 1999) release some of these methods.

SHARP, INC. and 3DT, INC. has developed the 2-eye method 3 dimensional displays for a flat panel. Users can see from one angle and cannot locate themselves anywhere to look at the 3D image.

SANYO, INC. has developed the 3 dimensional displays using pinholes. But in their method, it is not easy to make flat panel because it need extra-bright light source behind. Also, it is difficult to apply current technology to manufactures. It tends to be expensive. Also, the data conversion from 3D object to 2D liquid crystal takes too long time to be for run time application. And their resolution is low.

These inventions don't have clear enough 3D images, or high enough resolution. And users usually have to view 3D image from narrow angles with shallow depth. That is when users move around the images, images don't necessary show the full effect of 3D images. All of above has tendency give the stress to users eyes, and users may end up feeling dizzy after a while.

### OBJECTS AND ADVANTAGES

This invention has advantages relative to prior art in
1. This device of invention can display true realistic 3D image as if it is there.
2. Users can interact through 3D communicator device.
3. It has very wide view angles without much stress to users eyes
4. This can have very high 3D image resolution.
5. Multi users can have the view of 3D images
6. It could show both 2D and 3D images.
7. It can be manufactured easily using current 2D display technology
8. The 3D CAD/CAM, graphics to 3D display, 3D interaction conversion time is short.
9. This 3D communicator is light, bendable, flexible, efficient and low cost.
10. Colors doesn't get be polarized.

### SUMMARY

Here is the key words of this summary.

Key words:
Amorphous
Selectable
Priority-oriented
Dynamic-Simple-Choices of (Amorphous/selectable) static patterns
Dynamic-Simple-Choices of (Amorphous/selectable) dynamical patterns
Dynamic-Amorphous-Choices of (Amorphous/selectable) static patterns
Dynamic-Amorphous-Choices of (Amorphous/selectable) dynamical patterns
Touch panel
Network system
Communication device
Bendable, Flexibility
Bright, Clear
Realistic
FED, SED, OEL, LCD
Multi-layers (ex;1,2,3, . . . )

The first goal of this invention is to create the effect that users don't feel dizzy with longer time viewing of 3D images. There are several criteria that make this effect. This invention uses the amorphous or properly selectable patterns to soften the stress on the eyes of users. The selections need to be properly done to create 3D images. The concept of priority becomes important when we deal with amorphous-concept. Here, amorphous-concept is roughly defined. It is made of regular and irregular choices that create the purpose of objectives that removes the unwanted effects, due to reasons like reality. Here it could be various entities, such as things, physical entities, structures, patterns, networks, networking, choices, timings, and systems. The choice could be stationary, dynamical, and/or amorphous-like (amolfic/amolfous).

Roughly speaking, when the choice of amorphous-concept could create irregular frustrations that balances out the influences of outcomes to have desired stable results by removing undesired effects. In other similar words, it creates the stability that intends to have the desired effects meanwhile it intends to remove the undesired effects When this happens, let's call the effect as Amorphous-effect. For example, the amorphous-ly dynamic choices of amorphous patterns creates the effect of desired stability such as reduction of the stress on eyes of users, the higher resolution with wider view angles of good realistic quality images of multi-dimensions (such as 3D) meanwhile it removes undesired outcomes such as polarization of colors, flickering. The choices of amorphous-sequence and/or amorphous-patterns could be made by the set-up, random, and/or amorphously-prioritized sequence and/or patterns. This security, the choices of priorities, could be user accustomed and/or learned by artificial intelligence to accustom to users. The securer level of system, structures, networks, networking creates more comfort to people. These could have various extensions including modification of such concepts.

In the first method, when user(s) change angle or position, the image shows up differently so that the 3D image seems to be real. The masking pattern could have intensity gradient (difference) to in order to make amorphous-effects.

The 2D display displays the images for right and left eyes through holes/slots/lines/patterns/amorphous patterns. We call these as the patterns. Right eye can see only right 2D images and left eye can see only left 2D images because the patterns blocks the other. The fast liquid crystal the patterns in front of high-speed 2D display can be put to make the shift of the grids location so that it can change the location of the patterns. Or the patterns can be changed electrically and amorphously. The back images changes quickly and properly to make 3D images. Quick changing the location of the patterns make the images be higher resolution and wider view angle. And this amorphous choices creates user-friendly and/or user-eyes-friendly 3D images.

Also this could be in the way that single slot or multiple slots shifts to different direction. This could be done in one layer mask or multi-layers. For example, vertical slots moves horizontally and horizontal slots move vertically, and sloped slots move reverse-sloped. The angles of slots could have higher resolution on around vertical direction/angles. It could have oscillations. It could be harmonic oscillation. Slots are virtually rotating and/or shifting. Rotation and/or shifting could be three-dimensional. This could be done especially if the pattern generating means is for 3D structure. Lined/curved different shapes/slots/patterns could move around with order, regularly, amorphously or randomly. For example, multiple circles gaps/slots shift/move horizontally (x) and/or vertically (y) and/or depth-oriented (z) and/or spiral/circular/spinning. Again, this could have And/or combinations of such.

The most important portion of this invention is to have strata (layers) of dynamic patterns making means (masks). This is for the depth of views.

These could be done in topologically equivalent pattern(s) and topologically equivalent (virtual) motion(s)

### DRAWINGS

MAJOR DRAWING FIGURES

FIG. 1 shows the example diagrams of 3D display from angled view.

FIG. 17 shows the example diagrams of 3D display from side view.

FIG. 21 shows the example diagrams of patterns.

FIG. 38 shows the example diagrams of fast 2D display

FIG. 40 shows the example diagrams of flow chart of choices of amorphous patterns.

The rest of figures are described in another section.

### REFERENCE NUMERALS IN DRAWINGS

(0) light

(1) 3 dimensional image display

(2) 2 dimensional image display Or Back light
Such as
Liquid crystal display, ferro-electric liquid crystal display, plasma display, CRT, laser arrays, digital mirror device, nano-TV, array of electron-beam and light emitting display, array of carbon-nano-tube electron-beam and light emitting display, e-ink, e-display, Inorganic or Organic eluminescent display (O.E.L.), Field Emission Display (F.E.D.), e-ink, e-book, light

(3) Multi-layer image/pattern making means

such as at least on of liquid crystal, CF board, TFT board, liquid crystal pattern generating means, e-ink pattern making means, plasma display, CRT, O.E.L. mask, polar panel, cf board, tft board, source driver, gate driver, controller, battery

(5) Optional polar panels means

(7) Horizontal electrodes

(8) Vertical electrodes

(9) pattern-mask(s)

(10) light source

(19) slot(s), pattern(s)

(20) Optional special slot(s), pattern(s)

(21) Shaped slot(s), circular slot(s), oval slot(s), shaped pattern(s), circular pattern(s), oval pattern(s)

(22) multi-degrees (0, 1<single degree of freedom included>,2, 3, . . . n) of freedom movement(s), virtual motion, electrical motion, electrical shifts, electrical pattern change, virtual linear motion, virtual curved motion, virtual circular motion, virtual spiral motion

(25) multi-partition/divisional (0,1<single partition/divisional included>,2,3 . . . n) resolutions

(30) pattern(s), check board like pattern(s), knight pattern(s), sloped pattern(s), slot pattern(s), amorphous pattern(s)

(31) color pattern(s), color gradient pattern(s)

(32) complicated pattern(s)

(35) selections of pattern(s), virtual motion of pattern(s), pattern(s)

(37) topologically equivalent pattern(s)

(40) gap(s)

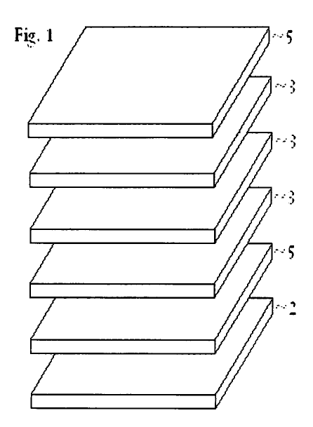

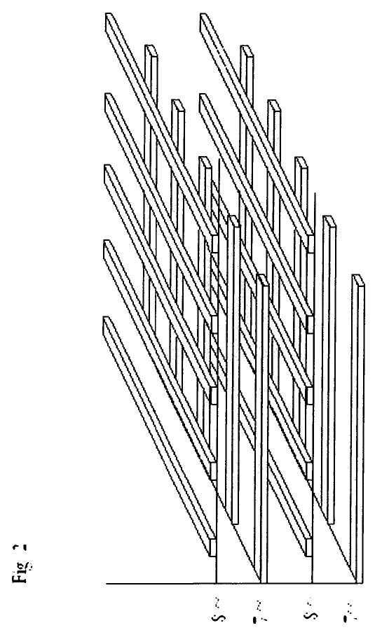

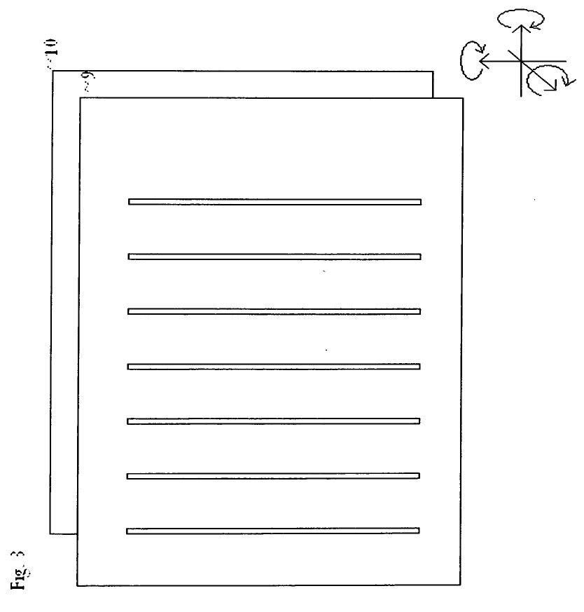

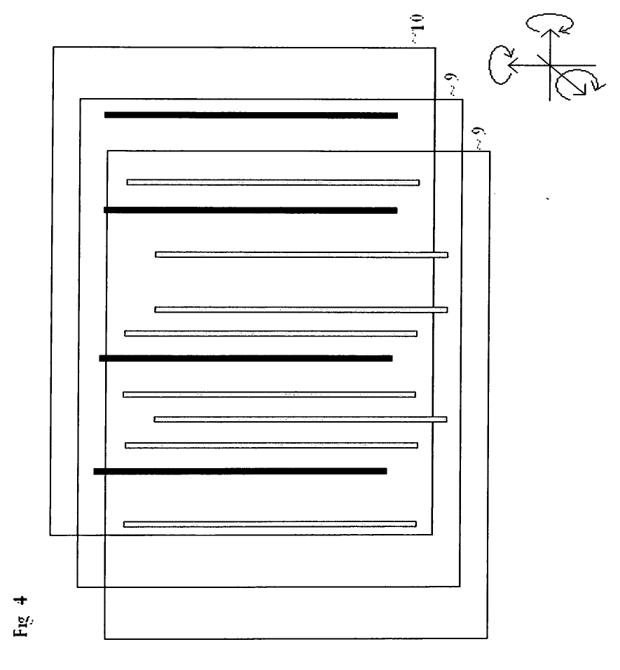

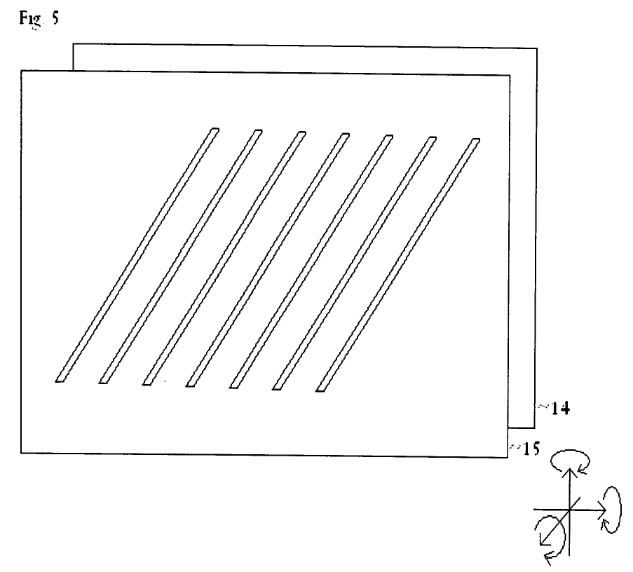

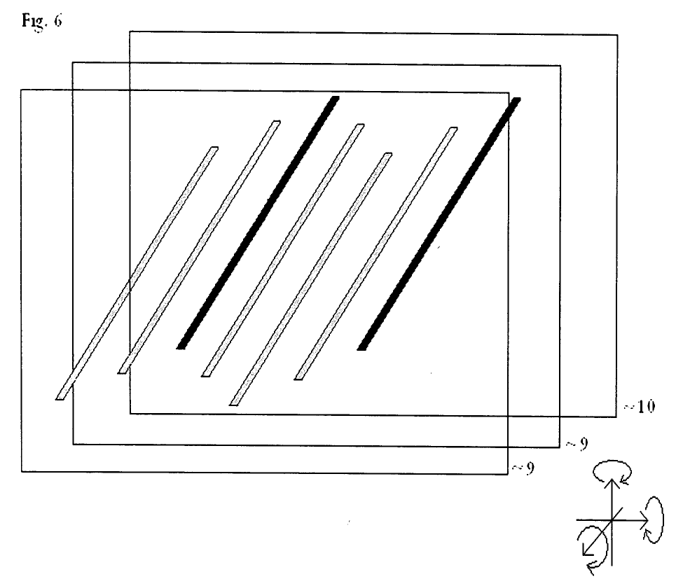

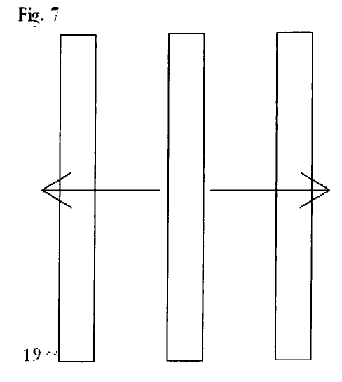

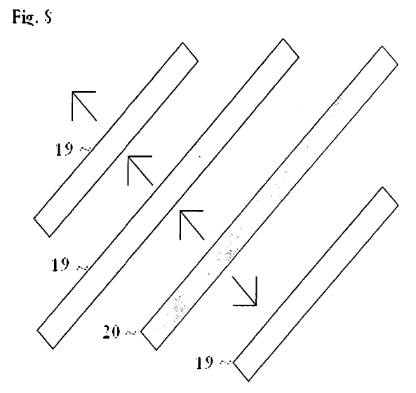

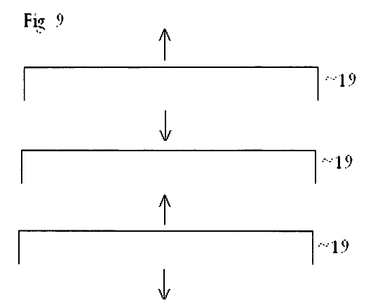

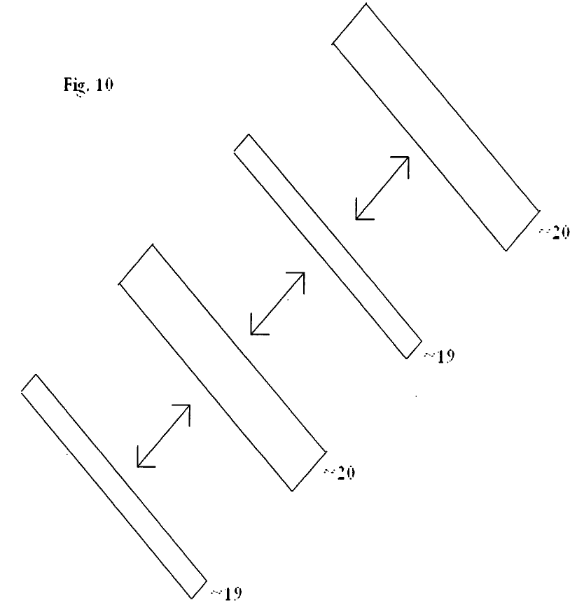

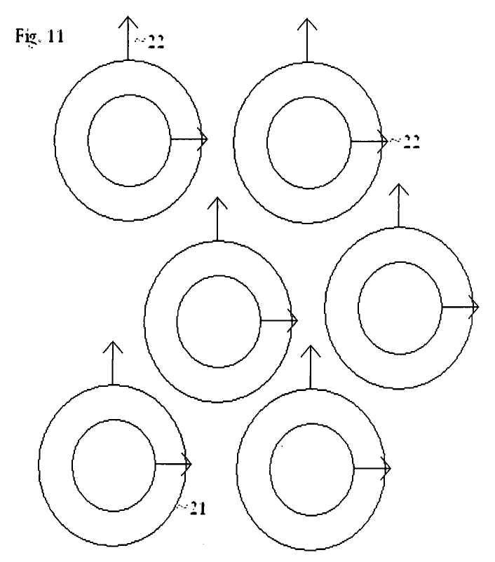

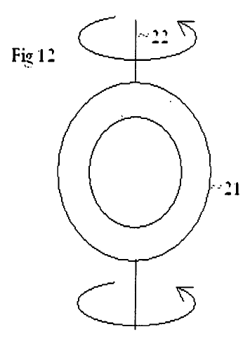

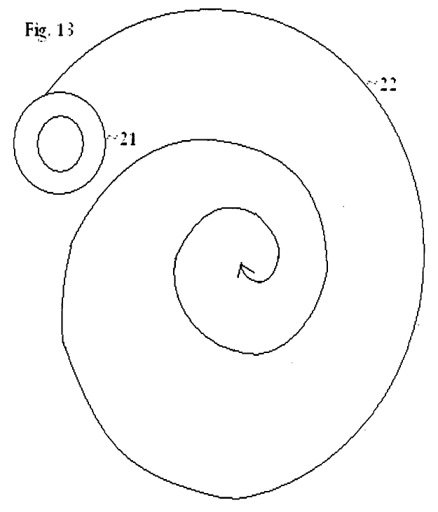

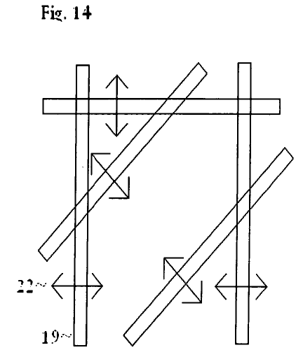

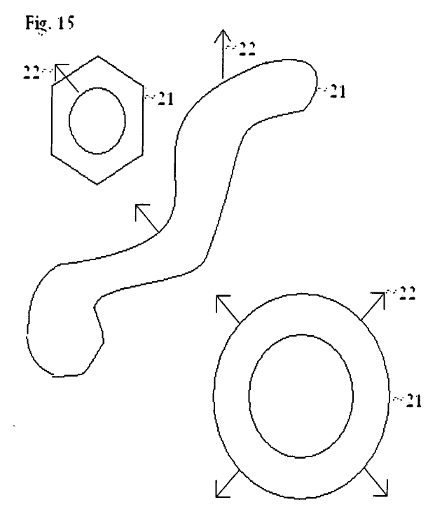

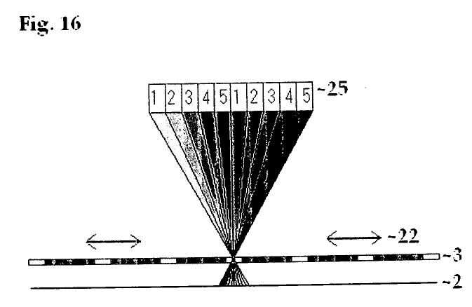

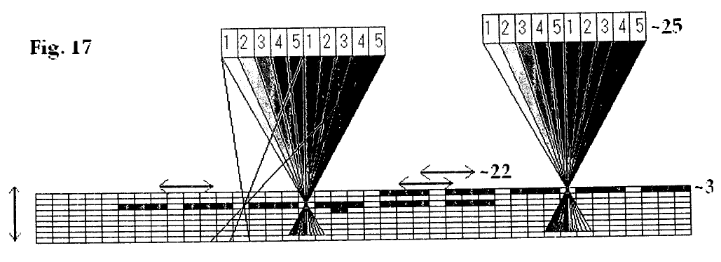

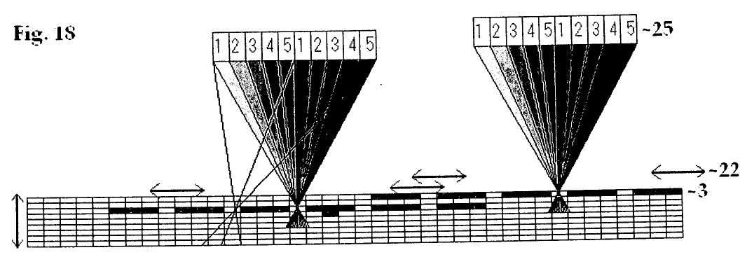

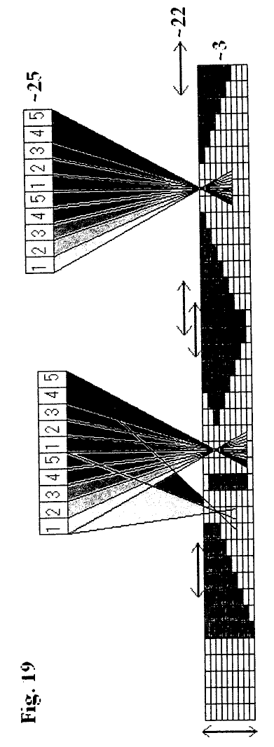

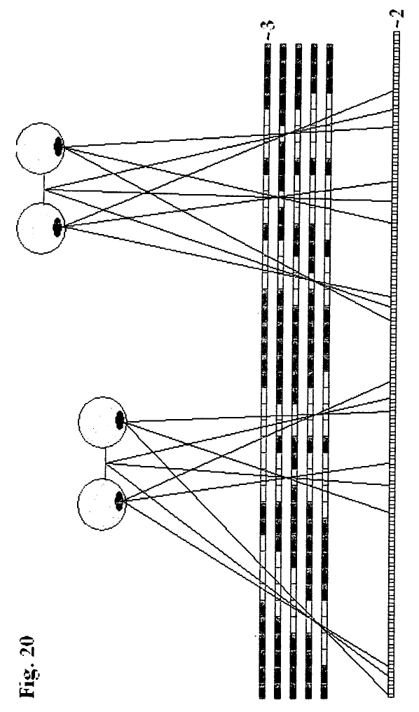

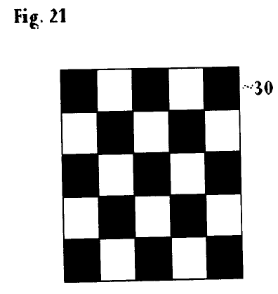

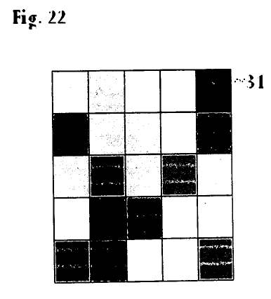

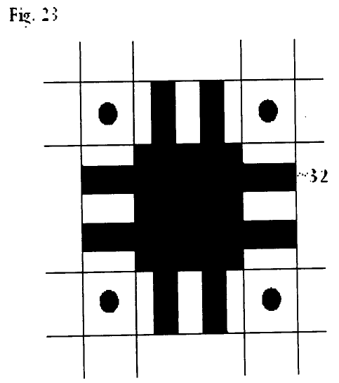

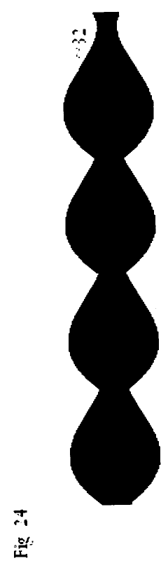

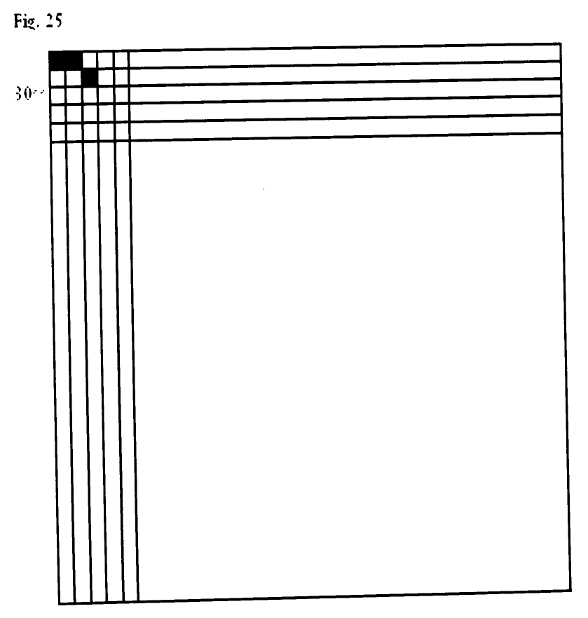

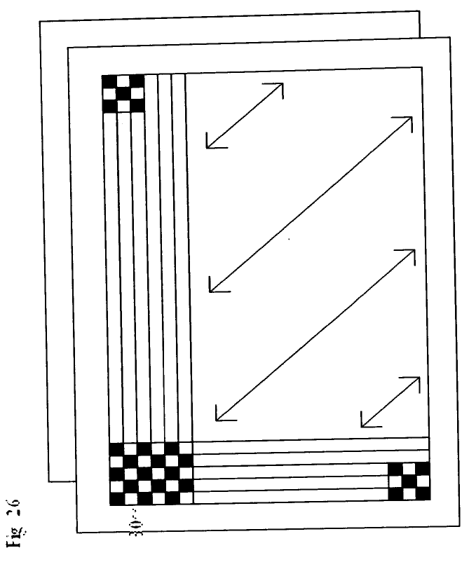

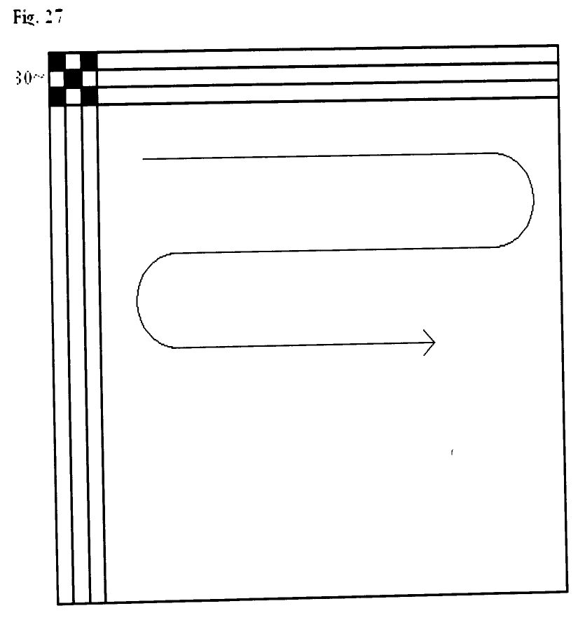

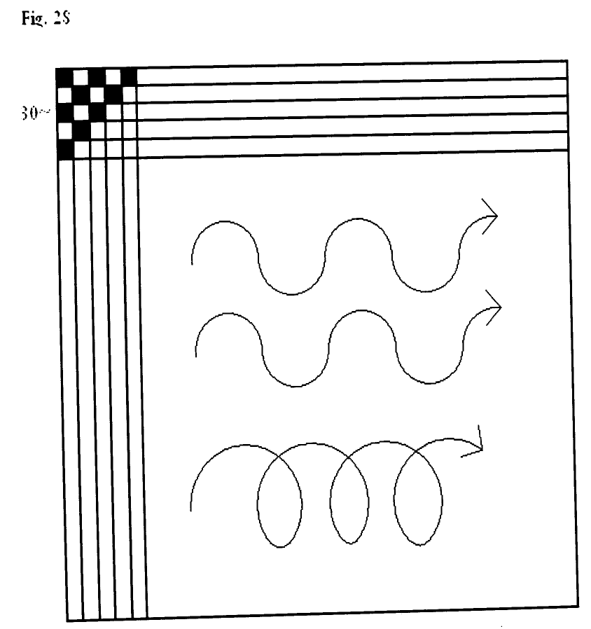

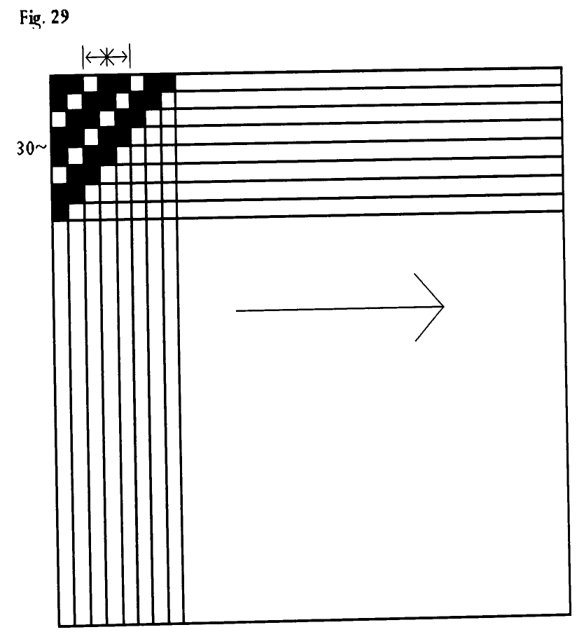

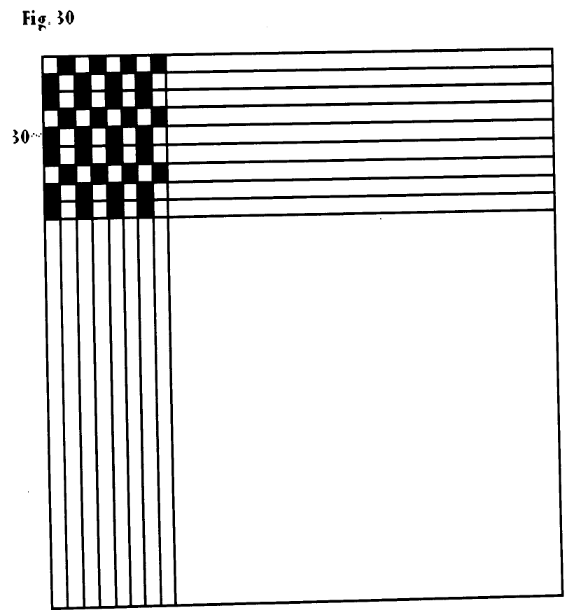

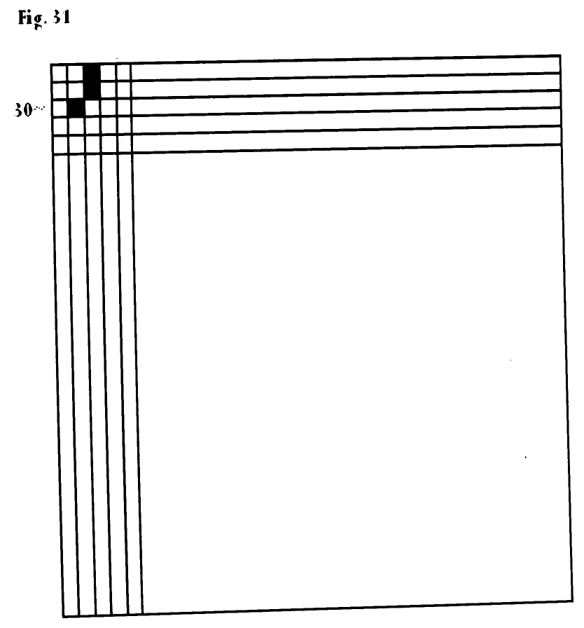

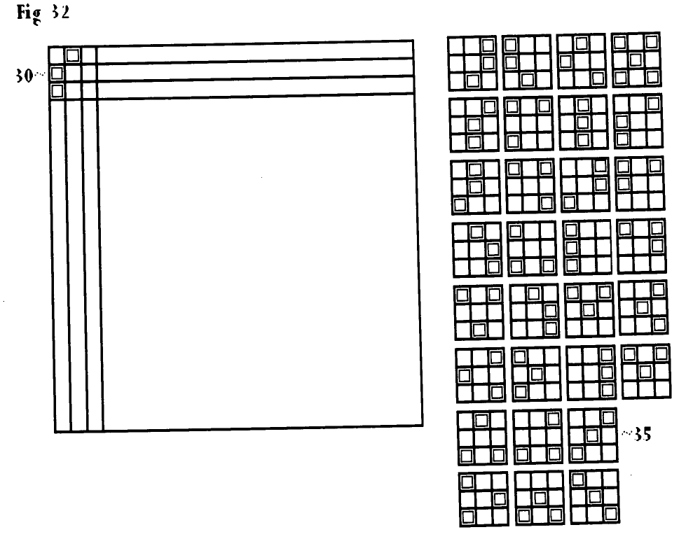

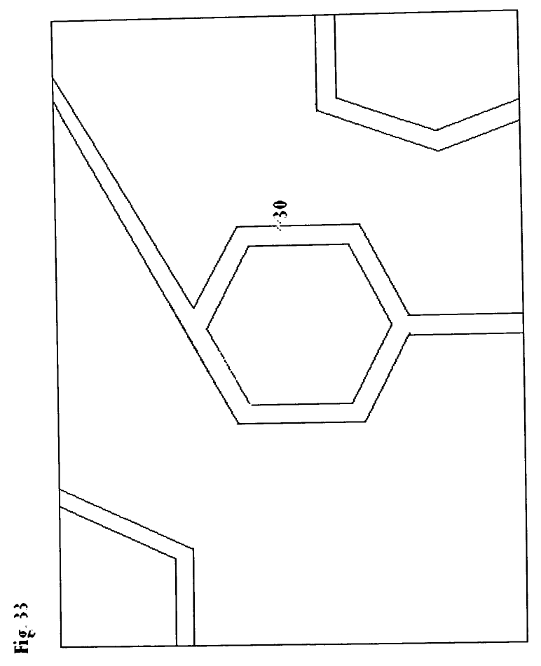

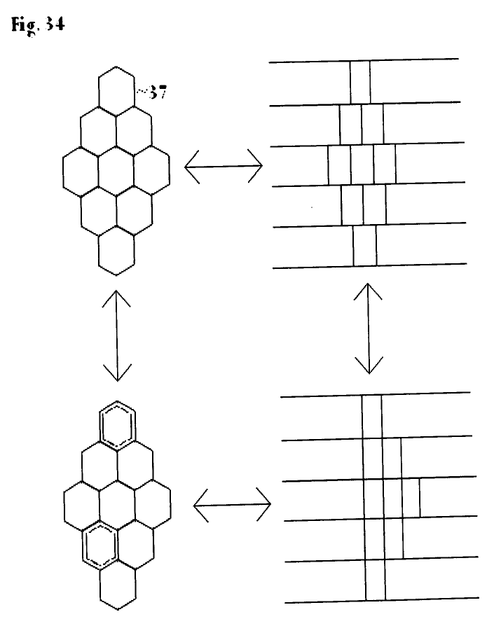

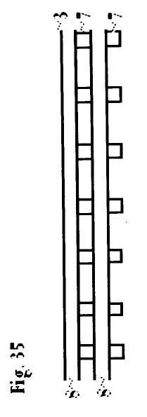

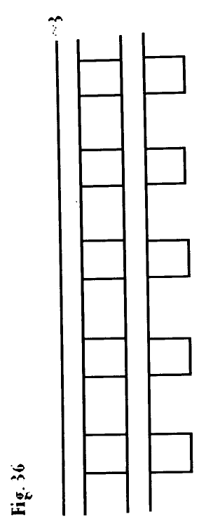

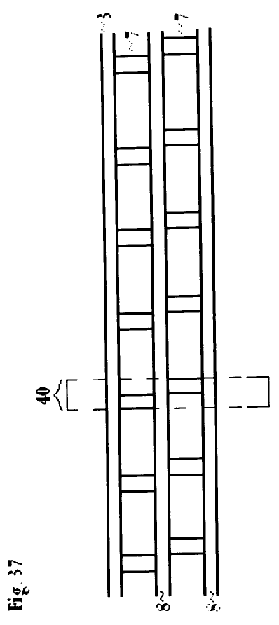

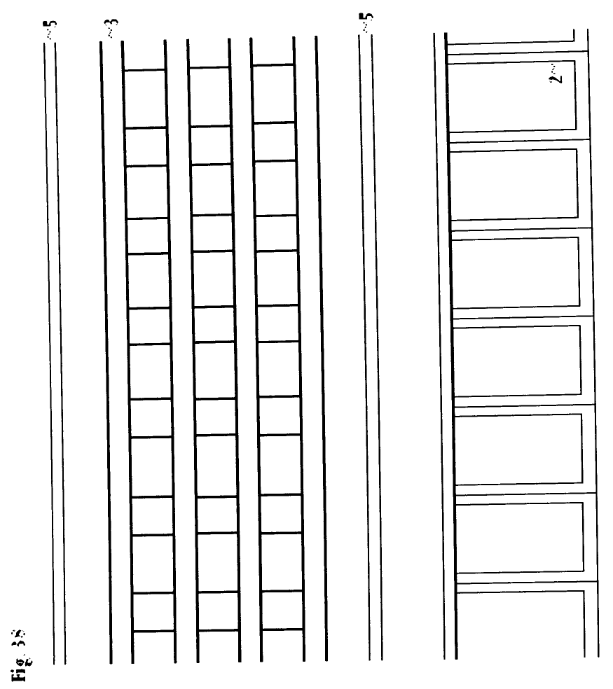

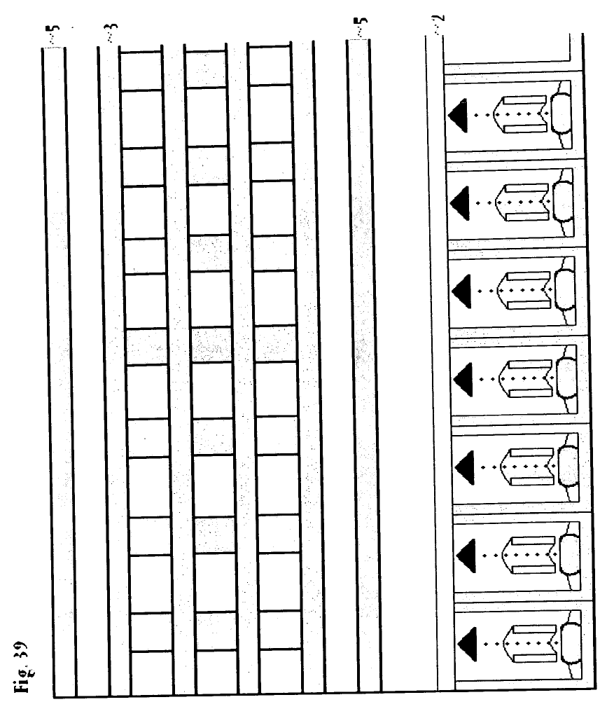

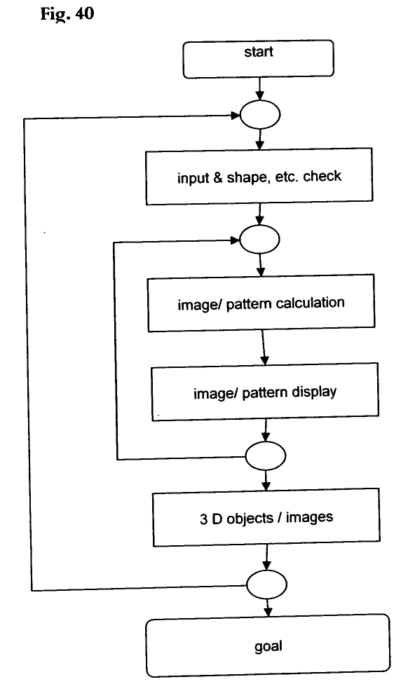

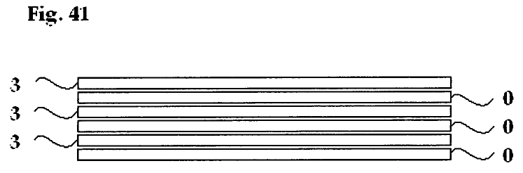

### Description—Figs. FIG. 1, FIG. 17, FIG. 21, FIG. 38, FIG. 40 Preferred Embodiment

A preferred embodiment of 3 dimensional Image Display inventions is illustrated in

FIG. 1, FIG. 17, FIG. 21, FIG. 38 and FIG. 40.

FIG. 1 shows the example diagrams of 3wD display from angled view.

FIG. 17 shows the example diagrams of 3D display from side view. This can be made of fast response liquid crystal panels with polar plate (5) and light source (2). The first mask-pattern-generator-means (3), such as ferroelectric/nematic liquid crystal, etc., creates the patterns. The high-resolution & high-speed 2 dimensional image display (2), such as liquid crystal, O.E.L., nano-tube display, and Arrayed e-display, creates the proper 2D picture-patterns to the mask-patterns will be converted to 3D image for right and left eyes. Picture-patterns on the pixels on 2D display and the mask-patterns (holes/the pattern) should be colored & intensified properly for 3D images. In order to have two eyes or different view angles, 2D images should have proper distributions based on the angles of views. Also, by having different locations of the patterns in fast response shifting or changing the locations, it produces the high resolution of 3 dimensional images. Patterns could be 3 dimensionally moved around. Patterns could be amorphously selected. Amorphous patterns could be prioritized by proper orders.

FIG. 21 shows the example diagrams of patterns. Different patterns are made and changed in 1, 2 or 3 dimensionally. These patterns could have more than 6 degrees of freedom, virtually at least. In this diagram, only check-board like patterns are made, but there are many topologically different patterns and topologically different patterns.

FIG. 38 shows the example diagrams of structures of 3 dimensional displays. Polar film (5), multi-layers liquid crystal pattern(s) generator (3), 2 dimensional display or light source (2) and drivers (3). CF board(s), liquid crystal(s), TFT board(s), source driver(s), gate driver(s), inverter(s), controller(s), battery(s), 2 dimensional display could be included. An example of 2 dimensional displays is organic eluminescent display.

FIG. 40 shows the example diagrams of flow chart of algorithm. Goal is to display the realistic 3 dimensional images. Optionally input signal comes from user(s) so that user(s) can interact with 3 dimensional image(s)/object(s). First, it checks the states, and operation of finding and express optimal pattern(s) and/or image(s).

### Description—The rest Alternative Embodiment

FIG. 2 shows the example diagrams of structure of layer electrodes of pattern generating means

FIG. 3 shows the example diagrams of patterns and virtual motion of patterns

FIG. 4 shows the example diagrams of patterns and 3 dimensional changes of patterns

FIG. 5 shows the example diagrams of tilted slots of motion

FIG. 6 shows the example diagrams of changed 3 dimensional patterns

FIG. 7 shows the example diagrams of trans. motion of shifting patterns.

FIG. 8 shows the example diagrams of virtually/electrically rotational slots motion after FIG. 7

FIG. 9 shows the example diagrams of virtually/electrically rotational slots motion after FIG. 8

FIG. 10 shows the example diagrams of position and motion of normal and special slots/pattern. Width of slot(s) could change.

FIG. 11 show the example diagrams of shaped (such as circular) slot(s)/pattern(s) and those motions. It has all directional gaps so that when it moves (such as linear, curve, combinational motion), it could cover all direction for users eyes.

FIG. 12 show the example diagrams of 3 dimensional shaped slot(s)/pattern(s) and 3 dimensional motion. Rotational motion with circular slot could be an example.

FIG. 13 show the example diagrams of oval slot(s)/pattern(s) and spiral motion in 3 dimension.

FIG. 14 show the example diagrams of combination of position and motion of shaped slot(s)/pattern(s). These could move independently or dependently.

FIG. 15 show the example diagrams of shaped slot(s)/pattern(s) could have variance including random shape(s), random motion(s), linear-like shape(s), linear-like motion(s), curve-like shape(s), curve-like motion(s), true-like shape(s), true-like motion(s)

FIG. 16 shows the example diagrams of side view of 3D display. There are several petitions/divisions for the displaying the 3D images. This could make higher resolution of 3 dimensional images. Each time users can change the angles, users can view different angle of 3 dimensional images.

FIG. 18 shows the example diagrams of side view of 3 dimensional displays. The bottom image could be up in the layer so that image could be clearer.

FIG. 19 shows the example diagrams of side view of 3 dimensional displays. The pattern(s) could be fill/half fill, and/or gradient-ly intensified. They can have different intensity(s) and/or pattern(s)

FIG. 20 shows the example diagrams of side view of 3 dimensional displays. It has gaps.

FIG. 22 show the example diagrams of slot(s)/pattern(s). It could be in color. It could be in pixel change/motion/shift. It could be black/white with on/off or with intensity differentiation.

FIG. 23 shows the example diagrams of complicated patterns. It could have different shapes, and/or different intensity, and/or different color, etc.

FIG. 24 shows the example diagrams of shaped reversed-slot(s) and/or pattern(s).

FIG. 25 shows the example diagrams of knight shape and/or motion. Motion could be simple, amorphous and/or complicated.

FIG. 26 shows the example diagrams of check-like pattern with various motions.

FIG. 27 shows the example diagrams of check-like pattern with combined-sliding motion

FIG. 28 shows the example diagrams of tilting patterns with waving motion and/or spiral motion.

FIG. 29 shows the example diagrams of shaped pattern and motion. The ratio of covered portion and slots portion could vary.

FIG. 30 shows the example diagrams of knight arrays patterns.

FIG. 31 shows the example diagrams of reverse-pattern(s). Or it could show 2 dimensional images in the between 3 dimensional images to create interesting effects.

FIG. 32 shows the example diagrams of selection if patterns are valid. This could be in blocks.

FIG. 33 shows the example diagrams of amorphous pattern(s) and motion pattern(s). Motion could have amorphous motion pattern(s).

FIG. 34 shows the example diagrams of topologically equivalent pattern(s). Motions could be topologically equivalent.

FIG. 35 shows the example diagrams of structure of multi-layer pattern generating means.

FIG. 36 shows the example diagrams of structural liquid crystal multi-layers.

FIG. 37 show the example diagrams of gaped grids/slides of pattern generating means. Positions of electrodes, etc. Grids do not have to be lined up perfectly. Properly arrange for the eye angle to image could be used.

FIG. 39 shows the example diagrams of structures of 3 dimensional display. Polar film (5), multi-layers liquid crystal pattern(s) generator (3), 2 dimensional display or light source (2) and drivers (3). CF board(s), liquid crystal(s), TFT board(s), source driver(s), gate driver(s), inverter(s), controller(s), battery(s), 2 dimensional display could be included. The field emission display is chosen for having fast image changes.

FIG. 41 shows the example diagrams of structure of multi-layer (0,1(single layer included), 2, 3, . . . n) display. For example, this can be 2 dimensional display and/or 3 dimensional display. It could be converted between 2 dimensional displays and 3 (and/or 4) dimensional display. Surface layer could be used for 2 dimensional display so that it shows clear(er) pictures. Layers could make proper patterns for 3 dimensional images. Light could be any light source. Light could be clear light source such as organic eluminescent display and/or back light. It is important to have single layer first. And it is important to have multiple-layers as piles up.

I claim:

1. The device that displays color 3 dimensional image(s) in the space in real time comprising group and topologically equivalent group comprising
1) High speed and high resolution 2 dimensional display means
2) Plurality of High speed and high resolution patterns masks
3) Optionally, control systems

2. The device of claim wherein said High speed and high-resolution 2 dimensional display means is composed of group and topologically equivalent group comprising
2 dimensional image display, liquid crystal display, ferro-electric liquid crystal display with polarizing plate with light source, source driver, gate driver, controller, battery, inverter, cf board, tft board, plasma display, television, monitor, laser arrays, digital mirror device, organic eluminescent display, field emission display, sed, diodes, light diode display, diode laser arrays, layers light emitter, sequential emission display, parallel emission display, matrix emission display, tensor emission display, nano-displays, nano-tube-displays, e-ink, e-book, gap, back light, light.

3. The device of claim wherein said plurality of High speed and high-resolution patterns masks means is composed of group and topologically equivalent group comprising
liquid crystal slots, ferro-electric liquid crystal slots, source driver gate driver, controller, battery, inverter, cf board, tft board, liquid crystal layers, electrical slots, physical slots, polar panels, plurality of patterns masks, plurality masks of patterns means, e-ink, e-book, e-mask, light, gap, light source, and reversed pattern(s)

4. The device of claim wherein said patterns means is composed of group and topologically equivalent group comprising
patterns,
Static/Dynamic Chess-patterns, Knight-patters, random-patterns, regular-patterns, amorphous-patterns, rotational slots, shift-rotational slots, circular patterns, oval patterns, spiral patterns, amorphous-patterns mean, combinations patterns motions, patterns motions,
Static/Dynamic Chess-patterns motions, Knight-patterns motions, random-patterns motions, regular-patterns motions, amorphous-patterns motions, rotational slots motions, shift-rotational slots motions, circular motion, oval motion, spiral motion, amorphous-patterns motions, combination motions.

5. The device of claim wherein said amorphous-patterns means is composed of the group and equivalent group comprising
crystal-like, quasi-crystal like, modified-silicon-like, gap.

6. The device that displays color 3 dimensional image(s) in the space in real time comprising group and topologically equivalent group comprising
1) Light controlling panel means
2) Multi-layers of pattern generating means
3) Light emitter means

7. The device of claim wherein said Light controlling panel means is composed of group and topologically equivalent group comprising
polar panels, polar films, films, sheets, plastic sheets, special plastic sheets, lens, prism, gap, light, light controller

8. The device of claim wherein said Multi-layer of pattern generating means is composed of group and topologically equivalent group comprising
Two-dimensional image patterns generators for three-dimensional images, mask patterns generator for three-dimensional images,
liquid crystal layer, tft layer, cf layer, source driver, controller, gate driver, battery, inverter, liquid crystal layers, liquid crystal slots, ferro-electric liquid crystal slots, electrical slots, physical slots, polar panels, e-mask, e-ink, plurality of patterns masks, plurality masks of patterns means, patterns, static/dynamic chess-patterns, knight-patterns, random-patterns, regular-patterns, amorphous-patterns, amorphous-patterns, elected-patterns means, oscillational slots, harmonically oscillational slots, rotational slots, shifting rotational slots, shifting oscillational slots, shifting-rotational-oscillatinal slots, circular slots, oval slots, spiral slots, circular motion, oval motion, spiral motion, gaps controlling, circular gaps shifting, oval gaps shifting, shaped gaps moving, shaped pattern spinning and shifting, circular rings spinning and shifting, oval gaps spinning and shifting, oval gap changing shape with spinning and shifting, shaped gaps rotating and shifting, controllers, controlling means, patterns motions, gap, reversed pattern(s), combination patterns, combination motion, light, light source

9. The device of claim wherein said Light emitter means is composed of group and topologically equivalent group comprising
light
back light units, inverters,
electron emitters, electron lens, electron-photon converter,
nano tubes, carbon nano-tubes, electron track controller, magnetic field generator, electric field enumerator, magnet, accerator, coil, luminous body, polar panels,
2 dimensional image display,
liquid crystal display, ferro-electric liquid crystal display with polarizing plate with light source, plasma display, television, monitor, laser arrays, digital mirror device, organic eluminescent display, field emission display, sed, diodes, light diode display, diode laser arrays, layers light emitter, sequential emission display, parallel emission display, matrix emission display, tensor emission display, nano-displays, nano-tube-displays, gap

10. The device of claim wherein said elected pattern means is group and virtually equivalent group comprising
formulated by nCm combinations where n-boxes selection in m-boxes formulated by less than nCm combinations where n-boxes selection in m-boxes

11. The device of claim wherein said controlling means is composed of group and topologically equivalent group comprising
computer control, optimal control, non-linear control, robust control, artificial intelligence control, neural network control

12. The device that displays image(s) in space in time comprising group and topologically equivalent group comprising
light means
image generating means

13. The device of claim wherein said light means is composed of group and topological equivalent group comprising
word, en-light, area, light, lamb, photon, beam, ray, wave, wave packet, flux, flow, fluid, film, charge, good emission, good submission,
back light, visual light, visual ray, image light, infrared ray, radio wave, micro wave, ultra violet ray, x ray, gamma lay, halogen lamp, eluminescent display, organic eluminescent display, inorganic eluminescent display, e-ink, electron beam, field emission display, 2 dimensional image display, liquid crystal display, ferro-electric liquid crystal, glass, plastic, optical instrument, reflector, converter, inverter, container, organic material, inorganic materials, alloys, air, water, solid, liquid gas, plasma, transformer, living, creature, cell, biochemical component, chemical component, object, program, software, hardware, driver, electrode, battery, charger, energy, existing, non-existing, brightness, darkness, world-wide-web, network,
multi-dimensional object, shape, slot, grid, imaging, image, pattern, patterning, rod, sphere, right shape, circle, oval, square, rectangular, polygon, motion, picture, movie, star ship, car, ship, space plane, rocket, dynamic, dynamics, stationary, stillness, going, doing taking, giving, loving, learning, morphing, modification, changing, etching, cutting, editing, adding, emitting, putting, dividing, shifting, lifting, ranching, jet, jetting, computing, -ing,
next, next of next, induction, deduction,
method, process, who, do, which, what, whom, where, when, why, how, preposition, noun, verb, adjective, adverb, perfect, past, present, future, prefix, stem, suffix, dictionary words, non-dictionary words, language, computing language,
number, ten, single, pleural, decimals, fractions, system, operator, operation, less than, bigger than, equal to,
zero, one, two, three, four, five, six, seven, eight, nine, a, b, c, d, e, f, g, h, i, j, k, l, m, n, o, p, q, r, s, t, u, v, w, x, y, z, mutation, mutant, engine, body, menu, formula, pressure, force, strong, stronger, arm-strong, I-am-strong, I am stronger, god is stronger, super, smallness, normalness, bigness,
element, connector, circuit, integrated circuit, central processing unit, memo, record, play, data, memory, display, inter-net, web, wire, wireless, communication, client, server, controller, bio-computer, nano, nano technology, nano-computer, robot, bio-noide,
black and white, positive and negative, in and out, hell and heaven, good and evil, zen and aku, special, case,
smartness wisdom, explosion, flying object, unidentified flying object, wild, nice, beauty, identity, ideology, between, distance, matrix, coordinate, space, time, space-time, timing, infinity, finite, intelligence, neural networks, artificial intelligence algorithm, logic, do, did, will, statement, sentence, paragraph, topology, mathematics, philosophy, physics, chemistry, biology, science, engineering, technology, religion, fragment, gather, together, loving-kindness, loving gods, loving neighbors, impression, expression, humanity, music, mod, art, hole, black hole, white hole, parallel universe, worm hole, multiple-universe, dark matter, bright matter, dimension, unit, scale, vector, tensor, pseudo-scale, pseudo-vector, pseudo-tensor, covariant, contra-variant, mixed, derivative, integration, integrity, calculation, computation, value, quality, quantity, vacuum, gap, nature, natural, defense, protection, security, personality, win, triumph, super-nature, supernatural, mortality, immortality, academics, sports, genetics, gene, nuclear energy, heat energy, solar energy, wind energy, real, unreal, high energy, low energy, usable energy, truth, fact, believe, belief, achievement, dream come true, dream sometime come true for some good people, nucleotide, electron, proton, neutron, quark, lepton, atoms, molecules, elementary particles, super strings, contradiction, opposite, coherent, woman, man, animals, plant, planet, fractuation, uncertainty, certainty, theory, practice, I love you, we love us, I love people, I, love, we, people, all, star, finance, group, organization, right, amaterasu, budda, christ, ala, la, mighty, gods, divine, divinity, universe,
all mighty, Love, God, power, powerful, strategy, yoshino universe SOMETHING GREAT

14. The device of claim wherein said image generating means is composed of group and topologically equivalent group comprising
Two-dimensional image patterns generators for three-dimensional images,
word, en-light, area, light, lamb, photon, beam, ray, wave, wave packet, flux, flow, fluid, film, charge, good emission, good submission,
back light, visual light, visual ray, image light, infrared ray, radio wave, micro wave, ultra violet ray, x ray, gamma lay, halogen lamp, eluminescent display, organic eluminescent display, inorganic eluminescent display, e-ink, electron beam, field emission display, 2 dimensional image display, liquid crystal display, ferro-electric liquid crystal, glass, plastic, optical instrument, reflector, converter, inverter, container, organic materials, inorganic materials, alloys, air, water, solid, liquid, gas, plasma, transformer, living, creature, cell, biochemical component, chemical component,
object, program, software, hardware, driver, electrode, battery, charger, energy, existing, nonexisting, brightness, darkness, world-wide-web, network,
multi-dimensional object, shape, slot, grid, imaging, image, pattern, patterning, rod, sphere, right shape, circle, oval, square, rectangular, polygon, motion, picture, movie, star ship, car, ship, space plane, rocket, dynamic, dynamics, stationary, stillness, going, doing, taking, giving, loving, learning, morphing, modification, changing, etching, cutting, editing, adding, emitting, putting, dividing, shifting, lifting, ranching, jet, jetting, computing, -ing,
next, next of next, induction, deduction,
method, process, who, do, which, what, whom, where, when, why, how, preposition, noun, verb, adjective, adverb, perfect, past, present, future, prefix, stems suffix, dictionary words, non-dictionary words, language, computing language,
number, ten, single, pleural decimals, fractions, system, operator, operation, less than, bigger than, equal to,
zero, one, two, three, four, five, six; seven, eight, nine, a, b, c, d, e, f, g, h, i, j, k, l, m, n, o, p, q, r, s, t, u, v, w, x, y, z, mutation, mutant, engine, body, menu, formula, pressure, force, strong, stronger, arm-strong, I-am-strong, I am stronger, god is stronger, super, smallness, normalness, bigness,
element, connector, circuit, integrated circuit, central processing unit, memo, record, play, data, memory, display, inter-net, web, wire, wireless, communication, client, server, controller, bio-computer, nano, nano technology, nano-computer, robot, bio-noide,
black and white, positive and negative, in and out, hell and heaven, good and evil, zen and aku, special, case,
smartness, wisdom, explosion, flying object, unidentified flying object, wild, nice, beauty, identity, ideology, between, distance, matrix, coordinate, space, time, space-time, timing, infinity, finite, intelligence, neural networks, artificial intelligence algorithm, logic, do, did, will, statement, sentence, paragraph, topology, mathematics, philosophy, physics, chemistry, biology, science, engineering, technology, religion, fragment, gather, together, loving-kindness, loving gods, loving neighbors, impressions expressions humanity, music, mod, art, hole, black hole, white hole, parallel universe, worm hole, multiple-universe, dark matter, bright matter, dimension, unit, scale, vector, tensor, pseudo-scale, pseudo-vector, pseudo-tensor, covariant, contra-variant, mixed, derivative, integration, integrity, calculation, computation, value, quality, quantity, vacuum, gap, nature, natural, defense, protection, security, personality, win, triumph, super-nature, supernatural, mortality, immortality, academics, sports, genetics, gene, nuclear energy, heat energy, solar energy, wind energy, real, unreal, truth, fact, believe, belief, achievement, dream come true, dream sometime come true for some good people, high energy, low energy, usable energy, nucleotide, electron, proton, neutron, quark, lepton, atoms, molecules, elementary particles, super strings, contradiction, opposite, coherent, woman, man, animals, plant, planet, fractuation, uncertainty, certainty, theory, practice, I love you, we love us, I love people, I, love, we, people, all, star, finance, group, organization, right, amaterasu, budda, christ, ala, la, mighty, gods, divine, divinity, universe,
all mighty, Love, God, power, powerful, strategy, yoshino universe SOMETHING GREAT
